(19) United States
(12) Patent Application Publication
(10) Pub. No.: US 2017/0280936 A1
(43) Pub. Date: Oct. 5, 2017

(54) FROLATOR FILTER BASKET

(71) Applicant: Edward T. Birkmanis, Chaplin, CT (US)

(72) Inventor: Edward T. Birkmanis, Chaplin, CT (US)

(21) Appl. No.: 15/083,750

(22) Filed: Mar. 29, 2016

(51) Int. Cl. A47J 37/12

(52) U.S. Cl. CPC A47J 37/1223

(57) ABSTRACT

A filtration apparatus for cooperation with an associated deep fat frying apparatus having a fry pot and a food basket movable by an operator between a position inside the fry pot and outside of the fry pot which includes a filter basket dimensioned and configured to fit within the associated fry pot and outside the food basket, said filter basket being generally rectangular and having an open top and perforate walls allowing passage of cooking oil through said perforate walls, said perforate walls preventing passage of particles having any dimension greater than 0.010 of an inch.

### TECHNICAL FIELD

The present invention is generally directed to apparatus for cooking food. More particularly, the present invention is directed to deep fat frying apparatus. Even more particularly, the present invention is directed to preventing food particles from mixing with the cooking oil.

### BACKGROUND OF THE INVENTION

The conventional fryolator uses a heating element to heat a tub of fryer oil to a temp suitable for cooking food properly. Regardless to the exact oil used, the standard process and procedures are the same in most fryolators. Most utilize a basket to raise food clear of the oil when cooking is finished. Food debris and food particle sedimentation contamination are an unavoidable by product of heating the oil and subsequently cooking the food in the same oil. Fryers are available with a variety of fry pot styles. A concern in the design and operation of such apparatus is larger food particles that sink to the bottom and then burn and taint the cooking oil.

During the cooking process, the particles of food, are expelled from the food directly into the oil. The buildup of these particles in the oil, cause the oil to lose its effectiveness, directly proportional to the amount of food cooked. The more fragments, the more contamination. As food is being fried, the fragments float in the oil. This is true in popular sizes of frylators having oil capacities of 30 to 35 gallons as well as larger and smaller capacities. The result is the same in all such apparatus. The food particles constitute sediment in the cooking oil and eventually settle to the bottom of the fryolator oil tank. The buildup of this sediment, results in a decrease in performance of the heating effectiveness of the oil. The higher the debris level, the greater the frequency and need to remove existing oil and replace the oil with new. It also necessitates the cleaning out of the fragments left in the bottom of the tank and surfaces of the fryolator tank.

It is known in the art to provide external complicated mechanical electric pump system that filters the oil. However, this approach attempts to rectify the particle contamination after the oil is contaminated with debris, and after settlement has occurred.

From the above, it is therefore seen that there exists a need in the art to overcome the deficiencies and limitations described herein and above.

### SUMMARY OF THE INVENTION

The shortcomings of the prior art are overcome and additional advantages are provided through a filtration apparatus for cooperation with an associated deep fat frying apparatus having a fry pot and a food basket movable by an operator between a position inside the fry pot and outside of the fry pot which includes a filter basket dimensioned and configured to fit within the associated fry pot and outside the food basket, said filter basket being generally rectangular and having an open top and perforate walls allowing passage of cooking oil through said perforate walls, said perforate walls preventing passage of particles 0.010 of an inch.

In some embodiments the filter basket includes a perforate bottom, rectangular perforate sides of substantially equal size and parallel as well as a rectangular perforate front and a rectangular perforate back that are of substantially equal size and parallel. In some embodiments the filter basket has a sandwich construction comprising portions overlapping a first sheet metal layer, a filter media layer and a second sheet metal layer.

The filter basket may have sandwich construction formed from a single piece of a first sheet metal layer, a single piece of filter media and a single piece of a second sheet metal layer. The first sheet metal layer and the second sheet metal layer may include a rectangular part that forms the bottom thereof and rectangular extensions from each of the four sides of the bottom that are bent to positions that are perpendicular to the bottom to form the filtration apparatus. Some embodiments may include a handle extending from a front thereof and/or a lip extending from the back thereof for suspending the filtration apparatus for draining oil.

The filter media may be a stainless steel mesh and the first and second sheet metal layers may be stainless steel.

It is an object of the present invention to prevent the particles from floating, saturating, settling and accumulating in the fryolator oil and tank.

It is an object of the present invention to provide apparatus that is simple to construct and use and which has no moving parts.

A further object of the present invention is to provide apparatus that does not require moving parts and/or electricity.

It is another object of the present invention to utilize filtration barriers to prevent the particle debris from building up in the oil and to simultaneously allow the oil to flow thru the apparatus and cook the food.

It is yet another object of the present invention to extend the serviceable life of the cooking oil and to thus reduce the costs for cooking oil.

It is a still further object of the present invention to reduce the labor requirements for maintaining fryolator equipment and thus to reduce the labor costs of commercial establishments.

It is still another object of the present invention to improve the quality of the food prepared in a fryolator apparatus because the overall quality of the cooking oil for any given time period will be of higher quality.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The foregoing and other objects, features and advantages of the invention will be apparent from the following more particular description of illustrative embodiments of the invention, as illustrated in the accompanying drawings in which like reference characters refer to the same parts throughout the different views. The drawings are not necessarily to scale, emphasis instead being placed upon illustrating the principles of the invention. Those skilled in the art will understand that the devices and methods specifically described herein and illustrated in the accompanying drawings are non-limiting exemplary embodiments. The features illustrated or described in connection with one exemplary embodiment can be combined with the features of other embodiments. Such modifications and variations are intended to be included within the scope of the present invention.

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a front view of a first embodiment of apparatus in accordance with the present invention,

FIG. 2 back view of the first embodiment of apparatus in accordance with the present invention,

FIG. 3 a top view of the first embodiment of apparatus in accordance with the present invention,

FIG. 4 a bottom view of the first embodiment of apparatus in accordance with the present invention,

FIG. 5 is a side view of the first embodiment of apparatus in accordance with the present invention,

FIG. 6 is a front view of a second embodiment of apparatus in accordance with the present invention,

FIG. 7 is a back view of the second embodiment of apparatus in accordance with the present invention,

FIG. 8 is a top view of the second embodiment of apparatus in accordance with the present invention,

FIG. 9 is a bottom view of the second embodiment of apparatus in accordance with the present invention,

FIG. 10 is a side view of the second embodiment of apparatus in accordance with the present invention, and

FIG. 11 is a partially schematic sectional view a wall of some embodiments of the apparatus in accordance with the present invention.

### DETAILED DESCRIPTION

The present invention utilizes a filtration media system that contains all the food particles in a basket. In a typical fryolator system, the food is cooked in special designed fryolator baskets. Food is placed into these baskets, and the baskets are placed into the heated oil, which in turn is contained by the fryolator tank. The fryolator basket is customarily perforated with large openings, to allow as much oil to enter and exit as possible while at the same time retaining the food.

The apparatus of the present invention accomplishes provides a structure that provide a filter that is small enough to filter the particle debris that would otherwise build up in the oil as well as large enough to simultaneously allows oil to flow thru the fryolator basket and cook the food.

The filtration utilizes a filter media that is an integral part of its structure. The fryolator filter basket in accordance with the present invention uses a 30-30 304 stainless steel wire fine mesh. Other filter materials could work such as ferrous and non-ferrous metals. Plated materials, fibers, plastics and composites may also potentially be utilized. A preferred embodiment of the fryolator filter basket in accordance with the present invention is constructed with 304 stainless steel. The properties of the stainless are far better suited for the high temperatures and prolonged exposure that the fryolator filter basket in accordance with the present invention will endure.

Temperatures in excess of 450 degrees, and 24 hours 7 days a week will not affect the performance and lifespan of the fryolator filter basket in accordance with the present invention. In a preferred embodiment the mesh prevents passage of particles having a maximum dimension greater than 0.010 inch. Thus, such particles will not pass thru the mesh and into the oil. However, the oil passes without any restriction. The mesh filter is what contains all the settlement, debris and any form of food particles from entering the main oil. The fine mesh filter, in itself, is not a rigid and non-flexible material. It can adjust to the difference in temperatures created by the fryolator heat settings by way of small expansion and contraction. It is also resilient enough to go from 450 degrees Fahrenheit in the fryolator immediately into a 165 degrees Fahrenheit environment such as a dishwasher or wash sink.

It is the burnt food and other debris that infiltrates the oil, since it is already in the oil without barriers in the prior art apparatus. The fryolator filter basket in accordance with the present invention purpose is designed to utilize filtration barriers to prevent the particle debris from building up in the oil as well as at the same time allowing oil to flow thru the fryolator filter basket in accordance with the present invention and cook the food.

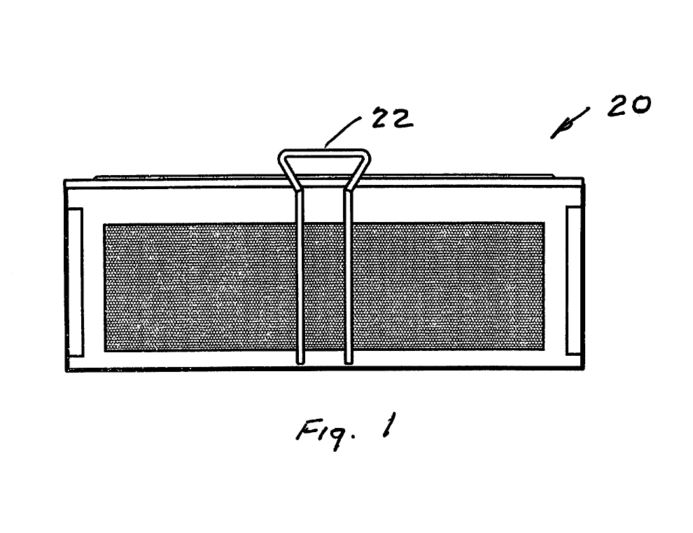

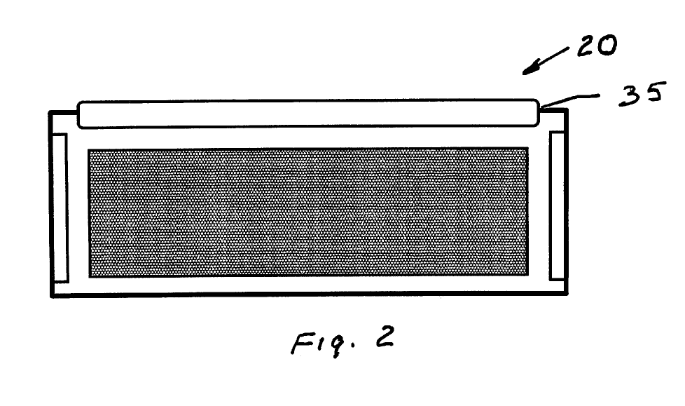

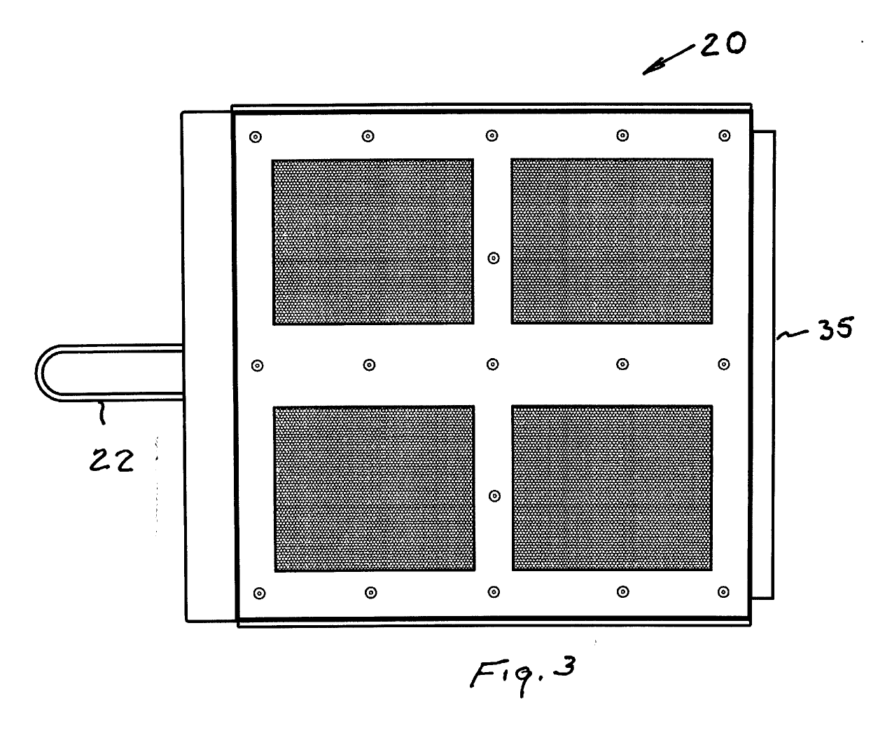

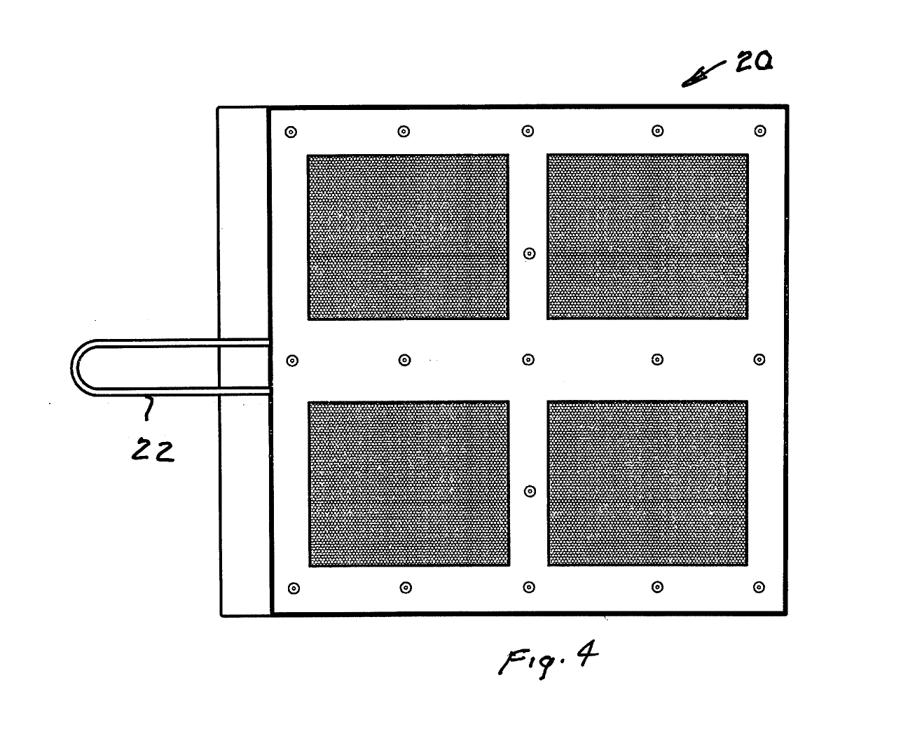

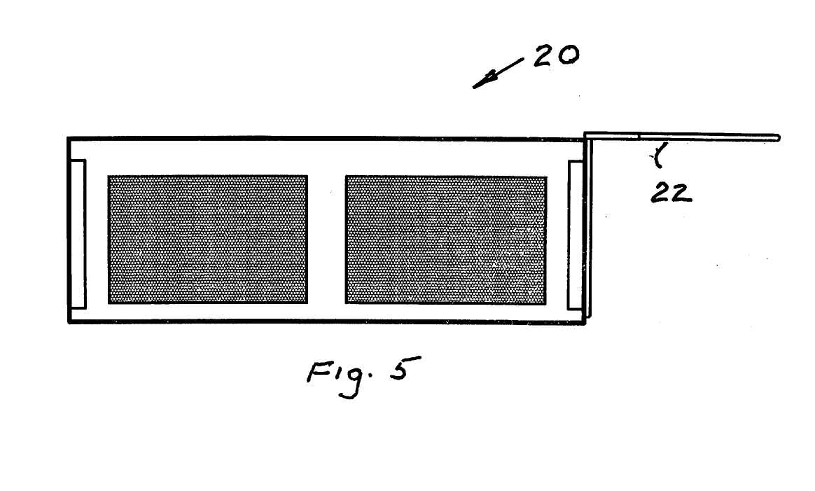

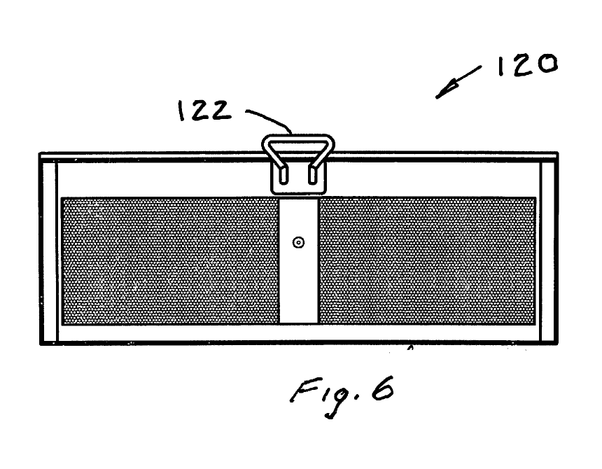

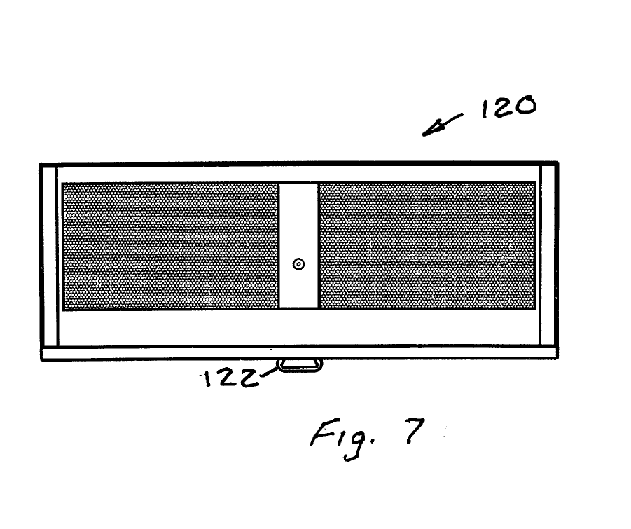

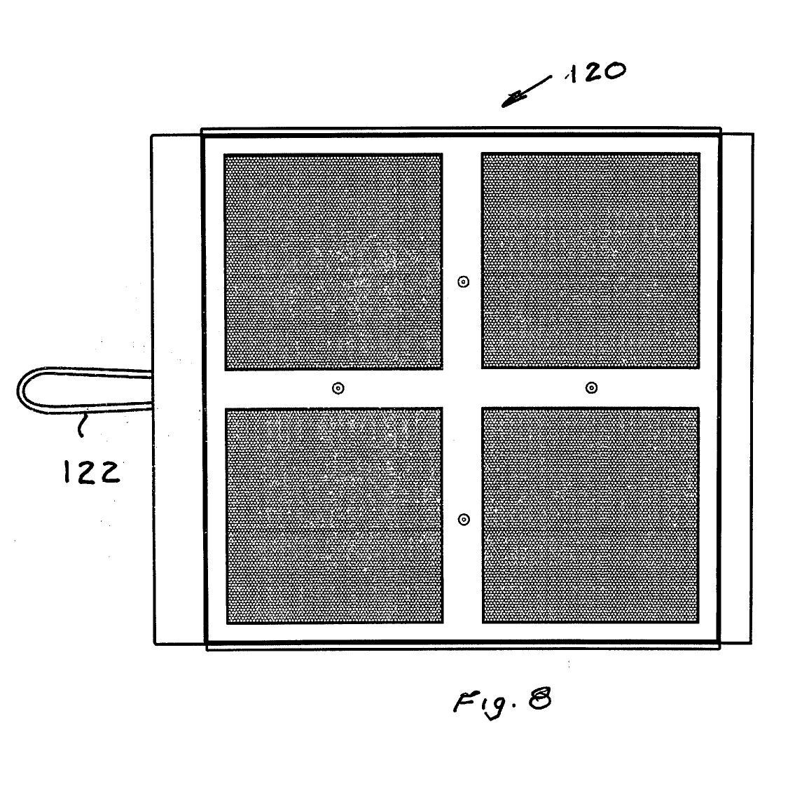

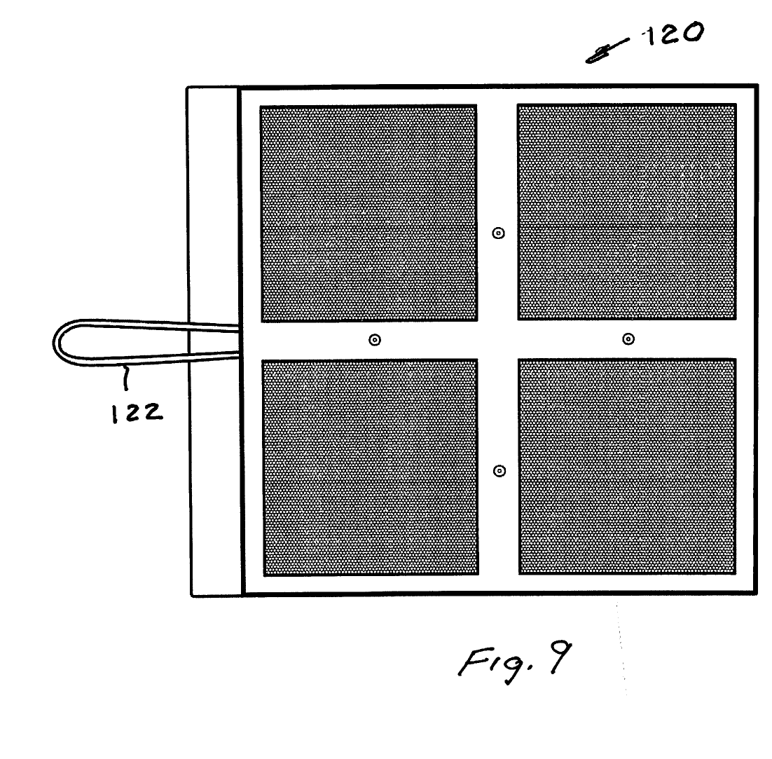

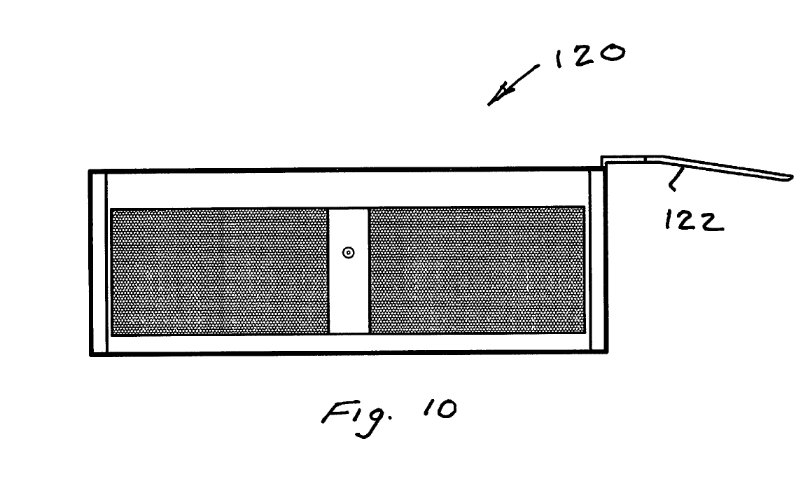

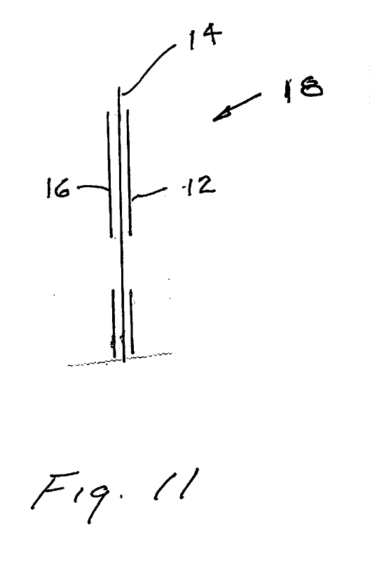

In order to support the filter media which may be referred to herein as a mesh 14 embodiments of the present invention include an external and internal frame are provided. FIG. 11 schematically illustrates the sandwich construction of the walls 18 of one form of the apparatus including an inner wall 12 and an outer wall 16 having aligned openings exposing an intermediate filter media 14. The first embodiment 20 illustrated in FIGS. 1-5 as well as the second embodiment 120 illustrated in FIGS. 5-10 illustrate a generally rectangular basket having front, back, side and bottom constructed in the manner shown in FIG. 11. The frames, which comprise the basket aspect of the fryolator filter basket in accordance with the present invention, are made from the same 304 stainless as is the mesh. The 304 material, is non-corrosive, strong, durable, temp resisting, and chemical safe. The frames encapsulate the fine mesh. Again, many materials could be used in place of the 304 stainless, but as with the mesh, the 304 is the material used in a preferred embodiment. Alternative materials include mild steel, nickel plated steel, or coated steel. Essentially, inside the external frame, the mesh is inserted. Inside the mesh, the internal frame is placed. As a result, akin to a sandwich, the basket is spot welded together to produce a unified assembly. The last component is the handle identified in the respective embodiments by the reference numeral 22 and 122. It also is 304 stainless, and provides a safe way to remove and place the fryolator filter basket in accordance with the present invention into the fryolator. It is attached by spot welded. The entire fryolator filter basket in accordance with the present invention contains only 4 separate parts. They are and outer skin, a filter media, an inner skin and a handle.

Some embodiments of the present invention include an elongated lip 35. The lip 35 has an inverted U-shaped cross-section dimensioned and configured for engaging a support whereby the apparatus may be mounted to allow drainage of cooking oil.

As mentioned above, the process to use a fryolator is to place food into a specific designed basket of large openings and wire frame construction. Food to be cooked is placed in this device, and placed directly into the fryolator into the oil. As a result the debris contaminate the oil, and aggravate the cleaning process. With the fryolator filter basket in accordance with the present invention, the procedure alters. The fryolator filter basket in accordance with the present invention is placed first into the oil, and rests on the heating element in the bottom of the tank. Next, the fryolator basket with food in place therein and is inserted into the fryolator filter basket in accordance with the present invention. The result is that now the food debris, are prevented from entering the oil, and are contained in the fryolator filter basket in accordance with the present invention. The heated fryolator oil, enters into the fryolator filter basket in accordance with the present invention thru the fine mesh unobstructed, cooks the food, and exits while the debris remains in the fryolator filter basket in accordance with the present invention. During the entire cooking process the fryolator filter basket in accordance with the present invention is constantly filtering out the food debris. The benefits are, longer and cleaner oil life, dramatically improved ease of cleaning the fryolator tank especially when oil is changed, and availability to remove the fryolator filter basket in accordance with the present invention while the fryolator is in operation. Even the food quality is improved by cleaner oil. The simplicity of the fryolator filter basket in accordance with the present invention is its own uniqueness. Continually filtration, no moving or mechanical or electrical parts, the ease of use and cleaning the fryolator filter basket in accordance with the present invention all contribute to its effectiveness. The fryolator filter basket in accordance with the present invention addresses and corrects a major problem of fryolators, since the fryolator has been in developed. The use of the fryolator filter basket in accordance with the present invention, in a fryolator, does not hamper or disrupt any of the functions of the fryolator. The apparatus results in making the fryolator more efficient, reduces labor required for cleaning and reduces the expense for replacement cooking oil.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A filtration apparatus for cooperation with an associated deep fat frying apparatus having a fry pot and a food basket movable by an operator between a position inside the fry pot and outside of the fry pot which comprises:
a filter basket dimensioned and configured to fit within the associated fry pot and outside the food basket, said filter basket being generally rectangular and having an open top and perforate walls allowing passage of cooking oil through said perforate walls, said perforate walls preventing passage of particles having any dimension greater than 0.010 of an inch.

2. A filtration apparatus as described in claim 1 wherein said filter basket includes a perforate bottom, rectangular perforate sides of substantially equal size and parallel as well as a rectangular perforate front and a rectangular perforate back that are of substantially equal size and parallel.

3. A filtration apparatus as described in claim 2 wherein said filter basket has a sandwich construction comprising portions overlapping a first sheet metal layer, a filter media layer and a second sheet metal layer.

4. A filtration apparatus as described in claim 3 wherein said filter basket sandwich construction is formed from a single piece of a first sheet metal layer, a single piece of filter media and a single piece of a second sheet metal layer.

5. A filtration apparatus as described in claim 4 wherein both said first sheet metal layer and said second sheet metal layer include a rectangular part that forms the bottom thereof and rectangular extensions from each of the four sides of the bottom that are bent to positions that are perpendicular to the bottom to form the filtration apparatus.

6. The filtration apparatus as described in claim 5 further including a handle extending from a front thereof.

7. The filtration apparatus as described in claim 5 further including a lip extending from the back thereof for suspending the filtration apparatus for draining oil from the filtration apparatus.

8. The filtration apparatus as described in claim 5 wherein said filter media comprises a stainless steel mesh.

9. The filtration apparatus as described in claim 5 wherein first and second sheet metal layers are stainless steel.
